(19) United States
(12) Patent Application Publication
(10) Pub. No.: US 2018/0215983 A1
(43) Pub. Date: Aug. 2, 2018

(54) Encapsulates

(71) Applicant: Encapsys, LLC, Appleton, WI (US)

(72) Inventors: Travis Ian Bardsley, Appleton, WI (US); Hanwei Zhang, Appleton, WI (US)

(73) Assignee: Encapsys, LLC, Appleton, WI (US)

(21) Appl. No.: 15/881,051

(22) Filed: Jan. 26, 2018

Related U.S. Application Data
(63) Continuation-in-part of application No. 15/880,743, filed on Jan. 26, 2018.
(60) Provisional application No. 62/451,387, filed on Jan. 27, 2017.

(51) Int. Cl. C09K 5/06; B01J 13/18

(52) U.S. Cl. CPC C09K 5/066; B01J 13/18; C09K 5/063

(57) ABSTRACT

The invention discloses a microencapsulated phase change material having a specific Thermal Efficiency Index (TEI). The composition of the invention comprises particles of a microencapsulated phase change material, the particles comprising a core and a shell that encapsulates the core, the shell comprising a polyurea obtained by polymerizing an isocyanate and an amine, prepared by (i) providing a water phase with an emulsifier, (ii) providing an internal phase of a core material and a multifunctional isocyanate soluble or dispersible in the internal phase, (iii) adding the internal phase to the water phase under high speed agitation to form an emulsion comprising droplets of the internal phase dispersed in the water phase and forming a first shell at an interface of the internal phase droplets and water phase mixture, and (iv) adding a multifunctional amine monomer to the emulsion thereby forming additional polyurea shell over the first shell at an interface of the internal phase droplets and water phase mixture. The resulting particles have a Thermal Efficiency Index greater than 0. Microcapsules according to the invention are highly effective at delivering enhanced thermal performance as compared to conventional microcapsules.

### CROSS-REFERENCE TO RELATED APPLICATIONS

This application is a continuation-in-part of U.S. Ser. No. 15,880,743 filed Jan. 26, 2018, and claims benefit of U.S. Provisional Application No. 62451387 filed Jan. 27, 2017.

### FIELD OF THE INVENTION

This invention relates to capsule manufacturing processes and microcapsules produced by such processes, and more particularly a process for forming microencapsulated phase change materials and an improved article based on such microcapsules.

### DESCRIPTION OF THE RELATED ART

Various processes for microencapsulation, and exemplary methods and materials are set forth in various patents such as Schwantes (U.S. Pat. No. 6,592,990), Nagai et al. (U.S. Pat. No. 4,708,924), Baker et al. (U.S. Pat No. 4,166,152), Woiciak (U.S. Pat. No. 4,093,556), Matsukawa et al. (U.S. Pat. No. 3,965,033), Matsukawa (U.S. Pat. No. 3,660,304), Ozono (U.S. Pat. No. 4,588,639), Irgarashi et al. (U.S. Pat. No. 4,610,927), Brown et al. (U.S. Pat. No. 4,552,811), Scher (U.S. Pat. No. 4,285,720), Shioi et al. (U.S. Pat. No. 4,601,863), Kiritani et al. (U.S. Pat. No. 3,886,085), Jahns et al. (U.S. Pat. Nos. 5,596,051 and 5,292,835), Matson (U.S. Pat. No. 3,516,941), Chao (U.S. Pat. No. 6,375,872), Foris et al. (U.S. Pat. Nos. 4,001,140; 4,087,376; 4,089,802 and 4,100,103), Greene et al. (U.S. Pat. Nos. 2,800,458; 2,800,457 and 2,730,456), Clark (U.S. Pat. No. 6,531,156), Saeki et al. (U.S. Pat. No. 4,251,386 and 4,356,109), Hoshi et al (U.S. Pat. No. 4,221,710), Hayford (U.S. Pat. No. 4,444,699), Hasler et al. (U.S. Pat. No. 5,105,823), Stevens (U.S. Pat. No. 4,197,346), Riecke (U.S. Pat. No. 4,622,267), Greiner et al. (U.S. Pat. No. 4,547,429), and Tice et al. (U.S. Pat. No. 5,407,609), among others and as taught by Herbig in the chapter entitled “Microencapsulation” in Kirk-Othmer Encyclopedia of Chemical Technology, V.16, pages 438-463.

Other useful methods for microcapsule manufacture are: Foris et al., U.S. Pat. Nos. 4,001,140 and 4,089,802 describing a reaction between urea and formaldehyde; Foris et al., U.S. Pat. No. 4,100,103 describing reaction between melamine and formaldehyde; and British Pat. No. 2,062,570 describing a process for producing microcapsules having walls produced by polymerization of melamine and formaldehyde in the presence of a styrenesulfonic acid. Forming microcapsules from urea-formaldehyde resin and/or melamine formaldehyde resin is disclosed in U.S. Pat. Nos. Foris et al., U.S. Pat No. 4,001,140; Foris et al., U.S. Pat. No. 4,089,802; Foris et al., U.S. Pat. No. 4,100,103; Foris et al., U.S. Pat. No. 4,105,823; and Hayford, U.S. Pat. No. 4,444,699. Alkyl acrylate-acrylic acid copolymer capsules are taught in Brown et al., U.S. Pat. No. 4,552,811. Each patent described throughout this application is incorporated herein by reference to the extent each provides guidance regarding microencapsulation processes and materials.

Interfacial polymerization is a process wherein a microcapsule wall such as polyamide, an epoxy resin, a polyurethane, a polyurea or the like is formed at an interface between two phases. Riecke, U.S. Pat. No. 4,622,267 discloses an interfacial polymerization technique for preparation of microcapsules. The core material is initially dissolved in a solvent and an aliphatic diisocyanate soluble in the solvent mixture is added. Subsequently, a nonsolvent for the aliphatic diisocyanate is added until the turbidity point is just barely reached. This organic phase is then emulsified in an aqueous solution, and a reactive amine is added to the aqueous phase. The amine diffuses to the interface, where it reacts with the diisocyanate to form polymeric polyurethane shells. A similar technique, used to encapsulate salts which are sparingly soluble in water in polyurethane shells, is disclosed in Greiner et al., U.S. Pat. No. 4,547,429. Matson, U.S. Pat. No. 3,516,941 teaches polymerization reactions in which the material to be encapsulated, or core material, is dissolved in an organic, hydrophobic oil phase which is dispersed in an aqueous phase. The aqueous phase has dissolved materials forming aminoplast (amine and aldehyde) resin which upon polymerization form the wall of the microcapsule. A dispersion of fine oil droplets is prepared using high shear agitation. Addition of an acid catalyst initiates the polycondensation forming the aminoplast resin within the aqueous phase, resulting in the formation of an aminoplast polymer which is insoluble in both phases. As the polymerization advances, the aminoplast polymer separates from the aqueous phase and deposits on the surface of the dispersed droplets of the oil phase to form a capsule wall at the interface of the two phases, thus encapsulating the core material. Urea-formaldehyde (UF), urea-resorcinol-formaldehyde (URF), urea-melamine-formaldehyde (UMF), and melamine-formaldehyde (MF), capsule formations proceed in a like manner. In interfacial polymerization, the materials to form the capsule wall are in separate phases, one in an aqueous phase and the other in an oil phase. Polymerization occurs at the phase boundary. Thus, a polymeric capsule shell wall forms at the interface of the two phases thereby encapsulating the core material. Wall formation of polyester, polyamide, and polyurea capsules also typically proceeds via interfacial polymerization.

Jahns, U.S. Pat. No. 5,292,835 teaches polymerizing esters of acrylic acid or methacrylic acid with polyfunctional monomers. Specifically illustrated are reactions of polyvinylpyrrolidone with acrylates such as butanediol diacrylate or methylmethacrylate together with a free radical initiator.

Common microencapsulation processes can be viewed as a series of steps. First, the core material which is to be encapsulated is typically emulsified or dispersed in a suitable dispersion medium. This medium is typically aqueous but involves the formation of a polymer rich phase. Most frequently, this medium is a solution of the intended capsule wall material. The solvent characteristics of the medium are changed such as to cause phase separation of the wall material. The wall material is thereby contained in a liquid phase which is also dispersed in the same medium as the intended capsule core material. The liquid wall material phase deposits itself as a continuous coating about the dispersed droplets of the internal phase or capsule core material. The wall material is then solidified. This process is commonly known as coacervation.

Jabs et al., U.S. Pat. No. 4,847,152 teaches microcapsules with polyurea walls. The wall is the reaction product of an aromatic isocyanate with an isocyanate reactive group. The isocyanate reactive group can include di- and polyamines such as N-hydroxyethylethylenediamine and ethylene-1,2-diamine.

Hotz et al., U.S. Pat. Pub. 2013/0089590 teaches a fragrance microcapsule with a polyurea wall. The shell in the reaction product of at least two difunctional isocyanates and a difunctional amine.

EP 1693104 Maruyyama discloses microcapsules having a polyurethane or polyurea wall obtained from polycondensation of a polyfunctional isocyanate with a polyfunctional amine.

Schwantes, U.S. Pat. Pub. 2009/0274905 teaches cationic microcapsule particles where the wall is the reaction product of an amine acrylate with a multifunctional methacrylate in the presence of an acid and initiator; or alternatively an acid acrylate and multifunctional (meth)acrylate in the presence of a base and initiator.

Applicant's U.S. Ser. No. 62/451,687, the disclosure of which is incorporated herein by reference, details an embodiment illustrated with acrylate microcapsules.

A problem in the art has been the inability to create a microcapsule while maintaining qualities such as low free wax, high latent heat, melt point at or near temperature of use, high weight retention such as in thermal gravimetric analysis (TGA) at 180° C., and low delta T in terms of difference between melt point peak and resolidification peak, in repeatable cycles. It has been exceedingly difficult to consistently fashion a microcapsule, particularly encapsulating a latent heat material or phase change material to have a melt point peak of not more than 30° C. and a resolidification point of not less than 18° C. where the difference between the respective melt point peak and resolidification peak is able to be controlled in repeated melting and resolidification cycles such that the difference between the melt point peak and resolidification peak is not more than 10° C.

Attempts to solve the problem of a large difference (ΔT) between the melting point and resolidification peak of microencapsulated phase change materials has involved attempts, such as taught by Lee US Publication 2004/0076826 and others, to include minor quantities, usually less than 15% by weight, or even less than 1% of either an inorganic or organic nucleating agent to prevent supercooling effects where solidification is depressed below a material's melting temperature.

Such systems known to date however typically have a latent heat storage density volumetrically less than the heat storage density of the microencapsulated phase change material of the invention.

A need exists for microencapsulated phase change materials having a low difference Δdelta of 10° C. or less difference) between the melting point peak and resolidification peak, low free wax, high latent heat, melt point at or near temperature of use, high weight retention such as in TGA tests and maintaining such attributes in a capsule stable over repeatable cycles.

A need exists for microencapsulated phase change materials having exceedingly low levels of residual free isocyanate monomer and residual free amine. The present inventions teach a solution for these needs.

### SUMMARY OF THE INVENTION

The present invention describes a microencapsulated phase change material having a differential scanning calorimetric melt point peak T1 microencapsulated phase change material of not more than 30° C. and a resolidification peak T2 of not less than 18° C., and wherein, the absolute value of, the difference between the respective melt point peak T1 and resolidification peak T2 is not more than 10° C. In a further embodiment, the microencapsulated phase change material comprises methyl palmitate. In a further embodiment, the microencapsulated phase change material has a latent heat of at least 165 Joules per gram. In one aspect, the microencapsulated phase change material comprises a blend of methyl palmitate and polyethylene. The phase change material can comprise a blend comprising from 50% to 97%, from 55% to 97%, or even 75% to 85% by weight (wt %) methyl palmitate. In another embodiment, the microencapsulated phase change material comprises from 70 to 95 wt % methyl palmitate, from 80 to 95 wt % methyl palmitate, or even from 82 to 88 wt % methyl palmitate. In yet a further embodiment the microencapsulated phase change material comprises (A) 0.1 to 20 wt % of straight chain alkane, or even 0.1 to 10 wt % of straight chain alkane, (B) 70 to 98 wt % of methyl palmitate and (C) 0 to 25 wt %, or even 0.1 to 25 wt %, or even 0.1 to 5 wt %, or even 0.1 to 2 wt % of one or more additional phase change materials other than phase change materials (A) and (B), wherein the weight percent of (A), (B), and (C) is based on the total weight of the phase change material. Ingredient (C) can be a polyalkylene, preferably a polyethylene or polypropylene, more preferably a low molecular weight polyethylene or polypropylene. The melt point of the phase change material, T1 for purposes of the calculation, is the melt temperature of the blend, thus individual components can be higher than 30° C.

In one aspect, the microencapsulated phase change material comprises a particle comprising a core material and a wall material that surrounds the core material, the particle having a Thermal Efficiency Index greater than 0, or of at least 1000, or even of at least 10,000.

In one aspect, the particle's wall material comprises a material selected from the group consisting of polyacrylate, polymethacrylate, polyamine, polyurea, polyurethane, melamine formaldehyde, and mixtures thereof. The particle's core material can comprise a material selected from the group consisting of 50 to 97 wt % of a methyl ester derived from palm oil, and from 0.1 to 20 wt % of a straight chain alkane based on total weight of the core. The core can include in addition from 0.1 to 25 wt % of a wax. The wax can be selected from the group of waxes consisting of alkane wax, polyethylene wax, carnauba wax, candelilla wax, vegetable wax, beeswax and paraffin wax.

Conventional polyurea formation involves reaction of polyisocyanate in the internal phase with a polyamine dispersed in an aqueous phase. A shell forms at the interface of the two phases.

A problem with interfacial processes has been the inability to efficiently form microcapsules with a wall material shell of high endurance. For certain applications, a need exists for a high strength shell able to survive repeated freeze-thaw cycles and to have a thermal efficiency index greater than 0.

It has been difficult to construct such a shell where the percentage by weight of the shell as compared to the weight of the microcapsule exceeds 1% by weight, and exceedingly difficult when the percentage by weight exceeds 3%, or even 5%, or yet even 10% by weight, or exceeding 12.5%, or 20%, as more mass in the shell wall involves more reactive material often making encapsulation difficult, and often gives rise to higher residuals.

The test methods provided herein measure isocyanate and amine residuals. Desirably residuals are reduced inside and outside of the microcapsule shell. The isocyanates are water insoluble, therefore isocyanate residuals are typically found internally in the core. The test for residuals of isocyanate herein measures the free isocyanate residuals in the capsule core.

The microcapsule of the invention teaches a microcapsule which overcomes these challenges, and more surprisingly exhibits low levels of amine or isocyanate monomer residuals. The isocyanate residuals test measures the residuals in the capsule core. The amine test measures the residuals external to the capsules.

In one aspect, the particle is comprised of at least 1 wt % of core material. In another aspect, the particle is comprised of from about 20 to about 95 wt % or even to about 99% of a core material, or even from about 50 to about 99 wt % of a core material.

Desirably the microencapsulated phase change material has a differential scanning calorimetric melt point peak T1 of the microencapsulated phase change material at not more than 30° C. and a resolidification peak T2 at not less than 18° C., and wherein the absolute value of the difference between the respective melt point peak T1 and resolidification peak T2 is not more than 10° C.

In one aspect, the microencapsulated phase change material core is a methyl ester selected from methyl laurate, methyl myristate, methyl palmitate, methyl stearate, or methyl oleate. Usefully, the phase change material has a latent heat of at least 165 Joules per gram.

The microencapsulated phase change material can comprise a core with the phase change material comprising a blend of methyl palmitate, octacosane and alkane wax, or optionally octadecane. The phase change material can comprise from 50 to 95 wt % of methyl palmitate; from 0 to 10 wt %, or even to 20 wt %, of octacosane; and from 0 to 30 wt %, or even to 40 wt %, of polyethylene wax. Alternatively, the phase change material can comprise from 55 to 95 wt % of methyl palmitate; from 0.1 to 10 wt % of octacosane; and from 0 to 30 wt % of one or more additional phase change materials other than methyl palmitate and octacosane, wherein the weight percent of the individual phase change materials is based on the total weight of the phase change material. Preferably the latent heat storage density is at least 165 Joules per gram, and preferably greater than 165 Joules per gram.

The invention teaches a composition comprising particles of a microencapsulated phase change material, the particles comprising a core and a shell that encapsulates the core, the shell comprising a polyurea obtained by polymerizing an isocyanate and an amine monomer, prepared by (i) providing a water phase with an emulsifier, (ii) providing an internal phase of a core material and a multifunctional isocyanate soluble or dispersible in the internal phase, (iii) adding the internal phase to the water phase under high speed agitation to form an emulsion comprising droplets of the internal phase dispersed in the water phase, (iv) adding a multifunctional amine monomer to the emulsion thereby forming an initial polyurea shell at an interface of the internal phase droplets and water phase mixture, and v) continuing reaction of the amine monomer and water with the multifunctional isocyanate monomer forming additional polyurea shell. The resulting particles have a Thermal Efficiency Index greater than 0.

In one aspect, in step (i), the water phase comprises, in addition, an amine catalyst or an amine catalyst is added to the emulsion. In step v) or in an additional step vi), sufficient time is allowed to continue reaction of the amine catalyst and water with the multifunctional isocyanate monomer forming additional polyurea shell at the interface. The composition of the invention has a low residual content of free amine monomer relative to the weight of the particles of the microencapsulated phase change material. The amount of free amine monomer of the composition of the particles of microencapsulated phase change material equals 3% or less, or even 2% or less, or even 1% or less, or even 0.5% or less, or even 0.1% or less by weight as compared to the weight of the microcapsules. The composition also has a low residual content of free isocyanate monomer. The test method measures the isocyanate residuals in the core of the microencapsulated phase change material. The amount of free isocyanate monomer of the microencapsulated phase change material equals 3% or less, or even 2% or less, or even 1% or less, as compared to the weight of the microcapsules. Particles as used herein refer to the microcapsules.

In one aspect, the amine catalyst is bis(2-dimethylaminoethyl)ether. Desirably the isocyanate is a multifunctional isocyanate, selected from aliphatic and aromatic isocyanates. The isocyanate, for example, can be dicyclohexylmethane-4,4′-diisocyanate.

In one aspect, the amine monomer is a multifunctional amine, selected from diethylene triamine, triethylene triamine, 1,6-diamine-n-hexane and hexomethylene diamine. The emulsifier can be various emulsifiers, such as sodium laureth sulfate.

In one aspect, the composition has a Thermal Efficiency Index of at least 600. The particle's core material can comprise a material selected from the group consisting of 50 to 97 wt % of a methyl ester derived from palm oil, and from 0.1 to 20 wt % of a straight chain alkane based on total weight of the core. The core can include, alternatively or in addition, from 0.1 to 25 wt % of a wax selected from the group of waxes consisting of alkane wax, polyethylene wax, carnauba wax, candelilla wax, vegetable wax, beeswax and paraffin wax. The particle comprises from about 20 to about 99 wt % of a core material.

The microencapsulated phase change material of the invention has a differential scanning calorimetric melt point peak T1 of the microencapsulated phase change material of not more than 30° C. and a resolidification peak T2 of not less than 18° C., and wherein the absolute value of the difference between the respective melt point peak T1 and resolidification peak T2 is not more than 10° C.

Alternatively, the microencapsulated phase change of the invention has a differential scanning calorimetric melt point peak T1 of the microencapsulated phase change material of not more than 32° C., or even 30° C., or even 28° C. and a resolidification peak T2 of not less than 16° C., or even 18° C., and wherein the absolute value of the difference between the respective melt point peak T1 and resolidification peak T2 is not more than 12° C., or even not more than 10° C., or even not more than 8° C.

In one aspect, the methyl ester is selected from methyl laurate, methyl myristate, methyl palmitate, methyl stearate, or methyl oleate, and in another aspect, the microencapsulated phase change material has a latent heat of at least 165 Joules per gram, or even 165 Joules per gram or greater, or even 170 Joules per gram or greater. The phase change material comprises a blend of methyl palmitate, octacosane and alkane wax.

In one aspect, the microencapsulated phase change material comprises from 50 to 95 wt % of methyl palmitate, from 0 to 20 wt % of octacosane and from 0 to 40 wt % of polyethylene wax. Alternatively, the core of the microencapsulated phase change material comprises from 55 to 95 wt % of methyl palmitate, from 0.1 to 10 wt % of octacosane and from 0 to 30 wt % of one or more additional phase change materials other than methyl palmitate or octacosane, and wherein the weight percent of the individual phase change materials is based on the total weight of the phase change material.

The invention makes possible articles of manufacture incorporating the microencapsulated phase change material. The articles include and can be selected from textiles, foams, pillows, mattresses, bedding, cushions, cosmetics, medical devices, packaging, cooling fluids, wallboard, and insulation.

In a further embodiment, the invention describes an improved article of manufacture incorporating the microencapsulated phase change materials described herein. The article of manufacture can be selected from textiles, foams, pillows, mattresses, bedding, cushions, cosmetics, medical devices, packaging, cooling fluids, wallboard, and insulation.

### DETAILED DESCRIPTION

Phase change materials, also known as latent heat absorbers, have found use in a variety of industrial, commercial and consumer applications such as on clothing, mattresses, bedding, pillows, packaging, containers, construction materials, wallboard materials, ceiling tiles, flooring, computer heat sinks, diving suites, cosmetics, and other applications where thermal moderation, thermal protection or heat dissipation is desirable, and particularly in repeatable thermal cycles.

Desirably phase change materials are sought which have thermal stability and are not degraded over repeated liquid solid phase change cycles. The present invention teaches a microencapsulated phase change composition surprisingly having a low difference ΔT between the melting point peak and resolidification peak, along with a surprisingly high latent heat storage density.

The invention surprisingly teaches a combination having a beneficial low difference ΔT between the melting point peak and resolidification peak, but also a high latent heat storage density than reported in current commercial products.

Surprisingly a high performing microencapsulated phase change material can be fashioned from a combination meeting the following relationship of a Thermal Efficiency Index (TEI).

TEI=α(RΔT)*β(RΔH)*γ(RMP)*δ(RTGA@180)*ϵ(RFW) Formula 1:

In the invention applicants discovered that the problem of achieving a microencapsulated phase change material having the combination of properties of the described delta T, melt point, low free wax, high TGA weight retention, in repeatable freeze thaw cycles can be solved to yield a surprisingly useful material having a desired combination of physical and chemical characteristics not able to be realized prior to the invention. Such chemical and physical characteristics are defined by the following parameters.

TEI=α(RΔT)*β(RΔH)*γ(RMP)*δ(RTGA@180)*ϵ(RFW)

Where:
α=constant weighting for RΔT (=20)
β=constant weighting for RΔH (=10)
γ=constant weighting for RMP (=5)
δ=constant weighting for RTGA @180 (=20)
ϵ=constant weighting for RFW (=15)
RΔT=rating for the difference between the peak temperatures on the melting and crystallization curves (0 to 1, <10° C.); scale is a sliding inverse scale from 0 to 1
RΔH=rating for melting latent heat (0 or 1, >165 J/g)
RMP=rating for peak melting temperature (0 to 1 based on relative difference from 28.5° C. in the range from 26° C. to 31° C.); rating is 1 at 28.5° C.
RTGA @180=rating for percent weight remaining at 180° C.; rating is 0 for 94% or less; rating is 0 to 1 for range 94% to 96%; rating is 1 for 96% or greater
RFW=rating for free wax (core) (0 to 1, <3%); scale is inverse; rating of 1 equals 0% free wax

The importance of each parameter is as follows:
a lower ΔT allows phase change material to get recharged much more quickly so it is available to provide expected performance;
a higher ΔH provides more latent heat storage density for comfort;
closer melting point to 28.5° C. would be ideal as it is the skin temperature that provides most comfort while body is at rest;
TGA @180 measurement represents the thermal stability of the product, with the higher the number, the better stability it would have in withstanding an increase in temperature, in particular during processing; and
free wax (core) level represents the level of phase change material outside of the capsule. The lower the level, the better the capsule would be.

For the five parameters in the TEI equation in Formula 1. A constant weighting is assigned to each parameter. Twenty is the maximum weighting and the weighting is assigned based on the relative influence on product performance.

Such parameters may be combined to yield a Thermal Efficiency Index.

In one aspect, applicants microencapsulated phase change material comprises a core material and a shell or wall material, said microencapsulated phase change material having a Thermal Efficiency Index greater than 0, or even greater or equal to 100, and preferably at least 600, and more preferably greater or equal to 100, or even 10,000 or greater. Values greater or equal to 600, or greater or equal to 1000 are desirable as more beneficial. The greater the TEI. The greater the perceived benefits.

Microencapsulated phase change material according to formula 1 exhibits a low difference ΔT, high heat storage density and ability for multiple phase transitions efficiently and without leakage or loss of thermal effect. The greater the value of TEI, the more beneficial is the microencapsulated phase change material.

The combination of the invention has closely spaced melt and freeze points with not more than about 10° C. separation between melt point peak and resolidification peak.

The microcapsules of the invention can be incorporated dry or as a coating or gel into a variety of commercial products including incorporated into foams, mattresses, bedding, cushions, added to cosmetics or to medical devices, incorporated into or onto packaging, dry wall, construction materials, heat sinks for electronics, cooling fluids, incorporated into insulation, used with lotions, incorporated into gels including gels for coating fabrics, automotive interiors, and other structures or articles, including clothing, footwear, personal protective equipment and any other article where thermal moderation or a cooling effect is deemed desirable.

The microcapsules protect and separate the phase change materials from the external environment. This facilitates design of microcapsule systems with distinct and narrow melt and resolidification peaks. The microcapsules facilitate improving flowability of the phase change materials enhancing ease of incorporation into articles such as foams or gels. The microcapsules can be used neat, or more often blended into coatings, gels or used as an aqueous slurry. The microcapsules help preserve the repeated activity of the phase change material and retain the phase change material to prevent leakage or infusion into nearby components when isolation of the microcapsules is desired.

Microencapsulation can be accomplished by a variety of techniques including physical methods such as spinning disk, fluidized bed, extrusion, spray drying or chemical methods such as coacervation, emulsion, polymerization, interfacial polymerization, solvent evaporation, layered deposition, fluid expansion, precipitation, phase separation and the like. Desirably, the microcapsules can be microcapsules or microcapsules less than 100 microns, or of a size less than 20 microns, or even less than 10 microns, or even less than1 micron.

The microcapsules of the present invention are manufactured according to the various processes described in the background section hereof, and illustrated in the appended examples. The microencapsulation processes are generally chemical microencapsulation based on techniques such as coacervation, free radical polymerization, interfacial polymerization, or in-situ polymerization.

In one aspect of the invention, a polymer shell is formed of the reaction product of a polyisocyanate with a multifunctional amine monomer. A shell is formed at an interface of two phases.

The particle's wall material can be produced by providing a water phase comprising an emulsifier and a multifunctional amine monomer. An internal phase is provided and comprises a multifunctional isocyanate along with a core material of a benefit agent, preferably a phase change material. Optionally, a nucleating agent, such as taught by Lee, US 2004/0076826 is included to facilitate supercooling prevention of the phase change material.

Multifunctional amine monomers useful in the invention include aliphatic, primary or secondary polyamines, and for purposes hereof also include di- or tri-amines, including but not limited to: ethylene-1,2-diamine, bis(3-aminopropyl)amine, N-methyl-bis(3-aminopropyl)amine, diethylenetriamine, triethylenetriamine, hydrazine-2-ethanol, bis(2-methylaminoethyl)methylamine, 1,4-diaminocyclohexane, 3-amino-1-methyl-aminopropane, N-hydroxyethylethylenediamine, N-methyl-bis(3-aminopropyl)amine, 1,4-diamino-n-butane, 1,6-diamino-n-hexane, ethylene-1,2-diamine-N-ethyl-sulphonic acid (as an alkali metal salt), hexamethylenediamine, hydrazine hydrate, 4,4′-diphenylmethanediamine, triethanolamine 1-aminoethylene-1,2-diamine, bis(N, N′-aminoethyl)ethylene-1,2-diamine, propylenediamine, tetraethylenepentaamine, pentamethylene hexamine, alpha, omega-diamines, propylene-1,3-diamine, tetramethylenediamine, pentamethylenediamine and 1,6-hexamethylenediamine polyethyleneamines, pentaethylenehexamine, 1,3-phenylenediamine, 2,4-toluylenediamine, 4,4′-diaminodiphenylmethane, 1,5-diaminoaphthalene, 1,3,5-triaminobenzene, 2,4,6-triaminotoluene, 1,3,6-triaminonaphthalene, 2,4,4′-triaminodiphenyl ether, 3,4,5-triamino-1,2,4-triazole, bis(hexamethylentriamine), 1,4,5,8-tetraaminoanthraquinone, and mixtures thereof.

The isocyanates useful in the invention are various multifunctional isocyanate monomers. For purposes hereof, “multifunctional isocyanates” include, but are not limited to, polyisocyanates, aliphatic isocyanates, and include aliphatic di- or tri-isocyanates, aromatic isocyanates, and can be 4,4-methylenebis(cyclohexyl)isocyanate also known as dicyciohexylmethane 4,4′-diisocyanate; hexamethylene 1,6-diisocyanate; isophorone diisocyanate; trimethyl-hexamethylene diisocyanate; trimer of hexamethylene 1,6-diisocyanate; trimer of isophorone diisocyanate; 1,4-cyclohexane diisocyanate; 1,4-(dimethylisocyanato) cyclohexane; biuret of hexamethylene diisocyanate; hexamethylene diisocyanate urea; trimethylenediisocyanate; propylene-1,2-diisocyanate; butylene-1,2-diisocyanate, aliphatic diisocyanates, aliphatic triisocyanates, tetramethylene diisocyanate, pentamethylene diisocyanate, hexamethylene diisocyanate, 4-(isocyanatomethyl)-1,8-octyl diisocyanate, aromatic polyisocyanates, 2,4-toluene diisocyanate, 2,6-toluene diisocyanate, naphthalene diisocyanate, diphenylmethane diisocyanate, triphenylmethane-p,p′,p″-trityltriisocyanate, toluene diisocyanate, polymethylene polyphenylisocyanate, 2,4,4′-diphenyl ether triisocyanate, 3,3′-dimethyl-4,4′-diphenyl thisocyanate, 3,3′-dimethoxy-4,4′diphenyl diisocyanate, 1,5-naphthalene diisocyanate, 4,4′,4″-triphenylmethane triisocyanate, isophorone diisocyanate, and mixtures thereof.

An emulsifier such as sodium laureth sulfate can be advantageous employed. For example, the water phase composition can contain an emulsifier to aid in the creation of the dispersion of the oil phase in the continuous water phase. Preferably the emulsifier is non-ionic emulsifier, to aid in the dispersion and/or solubility of the monomers.

Emulsifiers of all types are suitable for use in the practice of the present invention. The present teachings are applicable to anionic, cationic, non-ionic and amphoteric emulsifiers generally, preferred emulsifiers are the cationic and non-ionic emulsifiers, particularly those having polyalkylether units, especially polyethylene oxide units, with degrees of polymerization of the alkylene ether unit of greater than about 6. Preferred emulsifiers are those which significantly reduce the interfacial tension between the aqueous phase and dispersed phase, and thereby reduce the tendency for droplet coalescence. In this regard, generally the emulsifiers for use in the first water phase for aiding in the oil in water emulsion or dispersion will have HLB values of from 11 to 20. Of course, emulsifiers/surfactants of lower and higher HLB values that achieve the same objective as noted are also included.

Exemplary anionic surfactants and classes of anionic surfactants suitable for use in the practice of the present invention include: sulfonates; sulfates; sulfosuccinates; sarcosinates; alcohol sulfates; alcohol ether sulfates; alkylaryl ether sulfates; alkylaryl sulfonates such as alkylbenzene sulfonates and alkylnaphthalene sulfonates and salts thereof; alkyl sulfonates; mono- or di-phosphate esters of polyalkoxylated alkyl alcohols or alkylphenols; mono- or di-sulfosuccinate esters of C₁₂ to C₁₅ alkanols or polyalkoxylated C₁₂ to C₁₅ alkanols; ether carboxylates, especially alcohol ether carboxylates; phenolic ether carboxylates; polybasic acid esters of ethoxylated polyoxyalkylene glycols consisting of oxybutylene or the residue of tetrahydrofuran; sulfoalkylamides and salts thereof such as N-methyl-N-oleoyltaurate Na salt; polyoxyalkylene alkylphenol carboxylates; polyoxyalkylene alcohol carboxylates alkyl polyglycoside/alkenyl succinic anhydride condensation products; alkyl ester sulfates; naphthalene sulfonates; naphthalene formaldehyde condensates; alkyl sulfonamides; sulfonated aliphatic polyesters; sulfate esters of styrylphenyl alkoxylates; and sulfonate esters of styrylphenyl alkoxylates and their corresponding sodium, potassium, calcium, magnesium, zinc, ammonium, alkylammonium, diethanolammonium, or triethanolammonium salts; salts of ligninsulfonic acid such as the sodium, potassium, magnesium, calcium or ammonium salt; polyarylphenol polyalkoxyether sulfates and polyarylphenol polyalkoxyether phosphates; and sulfated alkyl phenol ethoxylates and phosphated alkyl phenol ethoxylates; sodium lauryl sulfate; sodium laureth sulfate; ammonium lauryl sulfate; ammonium laureth sulfate; sodium methyl cocoyl taurate; sodium lauroyl sarcosinate; sodium cocoyl sarcosinate; potassium coco hydrolyzed collagen; TEA (triethanolamine) lauryl sulfate; TEA (Triethanolamine) laureth sulfate; lauryl or cocoyl sarcosine; disodium oleamide sulfosuccinate; disodium laureth sulfosuccinate; disodium dioctyl sulfosuccinate; N-methyl-N-oleoyltaurate Na salt; tristyrylphenol sulphate; ethoxylated lignin sulfonate; ethoxylated nonylphenol phosphate ester; calcium alkylbenzene sulfonate; ethoxylated tridecylalcohol phosphate ester; dialkyl sulfosuccinates; perfluoro (C₆-C₁₈)alkyl phosphonic acids; perfluoro(C₆-C₁₈)alkyl-phosphinic acids; perfluoro(C₃-C₂₀)alkyl esters of carboxylic acids; alkenyl succinic acid diglucamides; alkenyl succinic acid alkoxylates; sodium dialkyl sulfosuccinates; and alkenyl succinic acid alkylpolyglycosides. Further exemplification of suitable anionic emulsifiers include, but are not limited to, water-soluble salts of alkyl sulfates, alkyl ether sulfates, alkyl isothionates, alkyl carboxylates, alkyl sulfosuccinates, alkyl succinamates, alkyl sulfate salts such as sodium dodecyl sulfate, alkyl sarcosinates, alkyl derivatives of protein hydrolyzates, acyl aspartates, alkyl or alkyl ether or alkylaryl ether phosphate esters, sodium dodecyl sulphate, phospholipids or lecithin, or soaps, sodium, potassium or ammonium stearate, oleate or palmitate, alkylarylsulfonic acid salts such as sodium dodecylbenzenesulfonate, sodium dialkylsulfosuccinates, dioctyl sulfosuccinate, sodium dilaurylsulfosuccinate, poly(styrene sulfonate) sodium salt, alkylene-maleic anhydride copolymers such as isobutylene-maleic anhydride copolymer, or ethylene maleic anhydride copolymer gum arabic, sodium alginate, carboxymethylcellulose, cellulose sulfate and pectin, poly(styrene sulfonate), pectic acid, tragacanth gum, almond gum and agar; semi-synthetic polymers such as carboxymethyl cellulose, sulfated cellulose, sulfated methylcellulose, carboxymethyl starch, phosphated starch, lignin sulfonic acid; maleic anhydride copolymers (including hydrolyzates thereof), polyacrylic acid, polymethacrylic acid, acrylic acid alkyl acrylate copolymers such as acrylic acid butyl acrylate copolymer or crotonic acid homopolymers and copolymers, vinylbenzenesulfonic acid or 2-acrylamido-2-methylpropanesulfonic acid homopolymers and copolymers, and partial amide or partial ester of such polymers and copolymers, carboxymodified polyvinyl alcohol, sulfonic acid-modified polyvinyl alcohol and phosphoric acid-modified polyvinyl alcohol, phosphated or sulfated tristyrylphenol ethoxylates.

Exemplary amphoteric and cationic emulsifiers include alkylpolyglycosides; betaines; sulfobetaines; glycinates; alkanol amides of C₈ to C₁₈ fatty acids and C₈ to C₁₈ fatty amine polyalkoxylates; C₁₀ to C₁₈ alkyldimethylbenzylammonium chlorides; coconut alkyldimethylaminoacetic acids; phosphate esters of C₈ to C₁₈ fatty amine polyalkoxylates; alkylpolyglycosides (APG) obtainable from an acid-catalyzed Fischer reaction of starch or glucose syrups with fatty alcohols, in particular C₈ to C₁₈ alcohols, especially the C₈ to C₁₀ and C₁₂ to C₁₄ alkylpolyglycosides having a degree of polymerization of 1.3 to 1.6., in particular 1.4 or 1.5. Additional cationic emulsifiers include quaternary ammonium compounds with a long-chain aliphatic radical, e.g. distearyldiammonium chloride, and fatty amines. Among the cationic emulsifiers which may be mentioned are alkyldimethylbenzylammonium halides, alkyldimethylethyl ammonium halides, etc. specific cationic emulsifiers include palmitamidopropyl trimonium chloride, distearyl dimonium chloride, cetyltrimethylammonium chloride, and polyethyleneimine. Additional amphoteric emulsifiers include alkylaminoalkane carboxylic acids betaines, sulphobetaines, imidazoline derivatives, lauroamphoglycinate, sodium cocoaminopropionate, and the zwitterionic emulsifier cocoamidopropyl betaine.

Suitable non-ionic emulsifiers are characterized as having at least one non-ionic hydrophilic functional group. Preferred non-ionic hydrophilic functional groups are alcohols and amides and combinations thereof. Examples of non-ionic emulsifiers include: mono and diglycerides; polyarylphenol polyethoxy ethers; polyalkylphenol polyethoxy ethers; polyglycol ether derivatives of saturated fatty acids; polyglycol ether derivatives of unsaturated fatty acids; polyglycol ether derivatives of aliphatic alcohols; polyglycol ether derivatives of cycloaliphatic alcohols; fatty acid esters of polyoxyethylene sorbitan; alkoxylated vegetable oils; alkoxylated acetylenic diols; polyalkoxylated alkylphenols; fatty acid alkoxylates; sorbitan alkoxylates; sorbitol esters; C₈ to C₂₂ alkyl or alkenyl polyglycosides; polyalkoxy styrylaryl ethers; amine oxides especially alkylamine oxides; block copolymer ethers; polyalkoxylated fatty glyceride; polyalkylene glycol ethers; linear aliphatic or aromatic polyesters; organo silicones; polyaryl phenols; sorbitol ester alkoxylates; and mono- and diesters of ethylene glycol and mixtures thereof; ethoxylated tristyrylphenol; ethoxylated fatty alcohol; ethoxylated lauryl alcohol; ethoxylated castor oil; and ethoxylated nonylphenol; alkoxylated alcohols, amines or acids; amides of fatty acids such as stearamide, lauramide diethanolamide, and lauramide monoethanolamide; long chain fatty alcohols such as cetyl alcohol and stearyl alcohol; glycerol esters such as glyceryl laurate; polyoxyalkylene glycols and alkyl and aryl ethers of polyoxyalkylene glycols such as polyoxyethylene glycol nonylphenyl ether and polypropylene glycol stearyl ether. Polyethylene glycol oligomers and alkyl or aryl ethers or esters of oligomeric polyethylene glycol are preferred. Also preferred as non-ionic emulsifiers are polyvinyl alcohol, polyvinyl acetate, copolymers of polyvinyl alcohol and polyvinylacetate, carboxylated or partially hydrolyzed polyvinyl alcohol, methyl cellulose, various latex materials, stearates, lecithins, and various surfactants. It is known that polyvinyl alcohol is typically prepared by the partial or complete hydrolysis of polyvinyl acetate. Accordingly, by reference to polyvinyl alcohol we intend to include both completely and partially hydrolyzed polyvinyl acetate. With respect to the latter, it is preferred that the polyvinyl acetate be at least 50 mole % hydrolyzed, more preferably, at least 75 mole % hydrolyzed.

Where the emulsifier is a polymeric emulsifier, especially one having or derived from an acrylic ester, e.g., a polyacrylate, the molecular weight is generally at least 10,000, preferably at least 20,000, most preferably 30,000 or more. Additionally, the amount of emulsifier is typically from about 0.1 to about 40% by weight, or even from about 0.2 to about 15 percent, or even from about 0.5 to about 10 percent by weight based on the total weight of the composition (based on dry solids). It is to be appreciated that certain polymers and copolymers may perform both as an emulsifier as well as a polymerizable and/or non-polymerizable component in forming the microcapsule wall. With respect to the latter, the polymeric emulsifier, particularly those in the nature of higher molecular weight polymers, are trapped and/or incorporated into the polymer wall as it is formed. This is especially likely where the nature of the water phase changes and the solubilized polymer comes out of solution.

In one aspect of the invention, a water phase is provided with amine catalyst and emulsifier. An internal phase of phase change material and multifunctional isocyanate is added to the water phase using high shear agitation to mill the emulsion to desired droplet size. A multifunctional amine monomer is then added to the oil in water composition. This second step enables forming shells where the weight of the shell as compared to the weight of the formed microcapsules exceeds 1% by weight, or even 3% by weight, or even 10% by weight.

The capsule formation process, after initial formation of a polyurea shell at an interface of internal phase droplets and a water phase, involves a hydrolysis reaction of the isocyanate monomer with water and an amine catalyst. The reaction of the isocyanate with water and/or multifunctional amine monomer in the absence of the amine catalyst is prolonged. With the catalyst, an initial thin shell is formed, and with a subsequent addition of multifunctional amine monomer to the oil-in-water dispersion, a shell results of surprisingly higher curability and higher shell weight relative to the weight of the capsule.

The amine catalyst can be a tertiary amine compound or a polyamine, desirably possessing catalytic activity for the reaction between the isocyanate and multifunctional amine monomer. The amine catalyst contains at least one tertiary amine group. Representative amine catalysts include tertiary amine compounds including, but are not limited to, bis(2-dimethylaminoethyl)ether, N,N′-dimethylacetylamine, diaminobicylcooctane, N, N′-dimethylaminoethanol, piperazine(ethyl)diamine, piperazinedidimethylaminopropylemine, dimethylaminoethoxypropylamine, pentamethyldiethylylenetriamine, trimethylamine, triethylamine, N-methylmorpholine, N-ethylmorpholine, N, N-dimethylbenzylamine, N, N-dimethylethanolamine, N, N, N′, N′-tetramethyl-1,4-butanediamine, N,N-dimethylpiperazine, 1,4-diazobicyclo-2,2,2-octane, bis(dimethylaminoethyl)ether, bis(2-dimethylaminoethyl)ether, morpholine, 4,4′-(oxydi-2,I-ethanediyl)bis, triethylenediamine, pentamethyl diethylene triamine, dimethyl cyclohexyl amine, N-cetyl N,N-dimethyl amine, N-coco-morpholine, N,N-dimethyl aminomethyl N-methyl ethanol amine, N,N,N′-trimethyl-N′-hydroxyethyl bis(aminoethyl)ether, N, N-bis(3 -dimethylaminopropyl)N-isopropanolamine, (N,N-dimethyl)amino-ethoxy ethanol, N,N,N′,N′-tetramethyl hexane diamine, 1,8-diazabicyclo-5,4,0-undecene-7, N,N-dimorpholinodiethyl ether, N-methyl imidazole, dimethyl aminopropyl dipropanolamine, bis(dimethylaminopropyl)amino-2-propanol, tetramethylamino bis (propylamine), (dimethyl(aminoethoxyethyl))((dimethyl amine)ethyl)ether, tris(dimethylamino propyl) amine, dicyclohexyl methyl amine, bis(N,N-dimethyl-3-aminopropyl) amine, N,N-bis (3-dimethylaminopropyl)-N-isopropanolamine, 1,3 -propanediamine, 1,2-ethylene piperidine, methyl-hydroxyethyl piperazine, dimethylaminopropyl-S-triazine, bisdimethylaminopropylurea and mixtures thereof.

The resultant polyurea capsule has reduced levels of free amine monomer outside of the particles of the microencapsulated phase change material. The free amine outside of the particles is 3% or less, or even 1% or less, or even 0.5% or less, or even 0.1% or less by weight, as compared to the total weight of the microcapsule.

The resultant capsule also has reduced levels of free isocyanate monomer, measuring 3% or less, or even 1% or less, or even 0.5% or less, or even 0.1% or less by weight as compared to the total weight of the microcapsule. The isocyanate is measured as the amount of residuals in the core.

Optionally, deposition aids can be included to increase deposition or adhesion of the microcapsules to various surfaces such as various substrates including but not limited to paper, fabric skin, hair, towels, or other surfaces. Deposition aids can include poly (acrylamide-co-diallyldimethylammonium chloride, poly (diallyldimethylammonium chloride, polyethylenimine, cationic polyamine, poly [(3-methyl-1-vinylimidazolium chloride)-co-(1-vinylpyrrolidone)], copolymer of acrylic acid and diallyldimethylammonium chloride, cationic guar, guar gum, an organopolysiloxane such as described in US Publication 20150030557, incorporated herein by reference. In a further embodiment, the above-described microcapsules can comprise a deposition aid, and in a further aspect the deposition aid coats the outer surface of the shell of the microcapsule.

In a further aspect the deposition aid can comprise a material selected from the group consisting of poly(meth)acrylate, poly(ethylene-maleic anhydride), polyamine, wax, polyvinylpyrrolidone, polyvinylpyrrolidone co-polymers, polyvinylpyrrolidone-ethyl acrylate, polyvinylpyrrolidone-vinyl acrylate, polyvinylpyrrolidone methylacrylate, polyvinylpyrrolidone-vinyl acetate, polyvinyl acetal, polyvinyl butyral, polysiloxane, poly(propylene maleic anhydride), maleic anhydride derivatives, co-polymers of maleic anhydride derivatives, polyvinyl alcohol, styrene-butadiene latex, gelatin, gum Arabic, carboxymethyl cellulose, carboxym ethyl hydroxyethyl cellulose, hydroxyethyl cellulose, other modified celluloses, sodium alginate, chitosan, casein, pectin, modified starch, polyvinyl acetal, polyvinyl butyral, polyvinyl methyl ether/maleic anhydride, polyvinyl pyrrolidone and its co polymers, poly(vinyl pyrrolidone/methacrylamidopropyl trimethyl ammonium chloride), polyvinylpyrrolidone/vinyl acetate, polyvinyl pyrrolidone/dimethylaminoethyl methacrylate, polyvinyl amines, polyvinyl formamides, polyallyl amines and copolymers of polyvinyl amines, polyvinyl formamides, and polyallyl amines and mixtures thereof.

In a yet further aspect, the deposition aid comprises a material selected from the group consisting of poly(meth)acrylates, poly(ethylene-maleic anhydride), polyamine, polyvinylpyrrolidone, polyvinylpyrrolidone-ethyl acrylate, polyvinylpyrrolidone-vinyl acrylate, polyvinylpyrrolidone methylacrylate, polyvinylpyrrolidone-vinyl acetate, polyvinyl acetal, polysiloxane, poly(propylene maleic anhydride), maleic anhydride derivatives, co-polymers of maleic anhydride derivatives, polyvinyl alcohol, carboxymethyl cellulose, carboxymethyl hydroxyethyl cellulose, hydroxyethyl cellulose, polyvinyl methyl ether/maleic anhydride, polyvinylpyrrolidone/vinyl acetate, polyvinyl pyrrolidone/dimethylaminoethyl methacrylate, polyvinyl amines, polyvinyl formamides, polyallyl amines and copolymers of polyvinyl amines, polyvinyl formamides, and polyallyl amines and mixtures thereof.

The phase change material of the invention is an alkyl ester of a hexadecanoate, and preferably the methyl ester such as methyl palmitate. Methyl palmitate, also known as methyl hexadecanoate, for example, has found little commercial adoption in microencapsulated phase change materials in the absence of the identification of the Thermal Efficiency Index of the invention as guidance.

Methyl esters of palm oil typically show multiple and broad melting transitions. Optionally to narrow peaks the methyl esters can be fractionated and optional additional materials such as nucleating agents could be added, though not required. Optionally, other additives could include halogenated flame retardants, such as mono- or poly-chlorinated or brominated paraffins. Flame retardants by way of illustration can include bromooctadecane, bromopentadecane, bromoeicosane or inorganics such as antimony oxide, or other oxides such as decabromodiphenyl oxide and the like.

A variety of methyl esters can be derived from palm oil, including:

| | | Melt Point |
|---|---|---|
| methyl laurate | (C12) | 5° C. |
| methyl myristate | (C14) | 18.5° C. |
| methyl palmitate | (C16) | 30.5° C. |
| methyl stearate | (C18) | 39.1° C. |
| methyl oleate | (C18) | −20° C. |

The Thermal Efficiency Index of the invention overcomes a problem of assembling useful commercial microencapsulated phase change product based on alkyl esters derived from palm oil. Microencapsulated phase change materials having a Thermal Efficiency Index greater than 0 and preferably of at least 600, surprisingly have a low ΔT difference in heating and melting, and have a high volumetric heat storage density, as compared to systems outside of parameters which the TEI provides.

### Test Methods

Latent Heat, Melt Temperature, and Delta T Determination

Instrument used is the TA DSC Q2000 (New Castle, Del.). The procedure is as follows:
1. Approximately a 3 to 10 mg dry sample of microcapsule is weighed into a T-Zero Hermetic pan.
2. Sample is placed on the DSC instrument with the following steps that are programmed into the software:
   Ramp 1.00° C./min from 50° C. to −10.00° C.
   Ramp 1.00° C./min from −10.00° C. to 50.00° C.
3. Resultant curve (as shown in FIG. 1) was then analyzed for the three properties:
   a. Latent heat, determined by integrating the area under the melting curve peak.
   b. Melt temperature, defined by the peak temperature on the melting curve.
   c. Delta T, defined by the difference between the peak temperatures on the melting and crystallization curves.

TGA Weight at 180° C., Determination

Instrument used is the TA Q50 TGA (Thermal Gravimetric Analyzer). The procedure is as follows:
1. Approximately 5-15 mg of dry sample is placed on to the weighing pan.
2. The sample is run on the instrument with the following step:
   Ramp 20.0° C./min to 800° C.
3. The resultant curve (as shown in FIG. 2) is then analyzed to determine the weight left at 180° C.

Free Wax Determination

Equipment used is the Agilent 7890N GC utilizing Chem Station Software and the Phenomenex's ZB-1HT Inferno Column @10M, 0.32 mm, 0.25 μm, 100%-dimethylpolysiloxane phase or equivalent. The method used is:
1. Temp: 50° C. for 1 minute then heat to 280° C. @10 C./min.
2. Injector: 270° C. with Split Ration of 10:1
3. Detector: 320° C.
4. 2 μl injection

The procedure is as follows:
1. 200 mg +/= 5% of dried powder is prepared in a 20 ml scintillation vial.
2. 10 ml of hexane is added to the vial with a calibrated air displacement micropipette and vial is placed on vortex mixer for exactly 5 seconds.
3. The sample is then left sitting for 2 minutes followed by removal of the hexane layer utilizing a syringe.
4. A 0.45 um syringe filter (or better) is placed on the syringe for transfer to a GC vial. The vial is then capped and run on a GC.
5. Resultant graph containing total area count and the internal standard area count is compared against a calibration curve to determine the % free core amount.

Residual Amine Monomer Measurement Method

Equipment used is the Agilent 7890N GC utilizing Chem Station Software and the Phenomenex's ZB 5MSI column @30M, 0.25 mm, 0.25 um, 100%-dimethylpolysiloxane phase or equivalent. The method used is:
1. Temp: 150° C. for 3 minutes then heat to 325° C. @15 C./min then hold for 2 minutes.
2. Injector: 280° C.
3. Detector: 325° C.
4. 4 μl injection

The procedure is as follows:
1. For the capsule slurry, the aqueous phase is separated from the capsule solids via vacuum or pressure filtration utilizing a 0.45um filter.
2. 500 mg of the aqueous phase is prepared in a 20 ml scintillation vial.
3. 5 mL of ethanol is added to the vial with a calibrated air displacement micropipette.
4. 1 drop of 21.5% NaOH (˜50 mg) is added to vial.
5. The vial is then capped and placed on vortex mixer for 10 seconds.
6. 3 mL of the resulting solution is then syringed.
7. A 0.45 um syringe filter is placed on the syringe for transfer to a GC vial.
8. The vial is then capped and run on a GC.
9. Resultant graph containing total area count and the internal standard area count is compared against a calibration curve to determine the residual amine monomer in the slurry.

Residual Isocyanate Monomer Measurement Method

Equipment used is the Agilent 7890N GC utilizing Chem Station Software and the Phenomenex's B-5 column @30M, 0.25 mm, 0.25 um, 100%-dimethylpolysiloxane phase or equivalent. The method used is:
1. Temp: 150° C. for 3 minutes then heat to 325° C. @15 C./min then hold for 2 minutes.
2. Injector: 280° C.
3. Detector: 325° C.
4. 4 μl injection

The procedure is as follows:
1. A quantity of the capsule slurry is prepared in a 20 ml scintillation vial, such that 350 mg of capsule solids is placed into the vial. Amount of slurry will be 350 mg/(slurry solids).
2. The vial is then filled full with purified water.
3. The resulting slurry is then filtered through a 0.45 um filter via vacuum filtration.
4. The resulting retained slurry solids is washed with 30 mL of purified water via vacuum filtration.
5. The resulting washed slurry solids is then placed into a 30 mL wide mouth jar and placed in 60 C oven for 8 hours to dry.
6. 300 mg of the resulting dried solids is prepared in a 20 ml scintillation vial.
7. 2.5 ml of acetone is added to vial with a calibrated air displacement micropipette.
8. 2.5 ml of hexane is added to vial with a calibrated air displacement micropipette.
9. The vial is capped and placed on vortex mixer for 10 seconds.
10. The capped vial is wrapped with electrical tape to best maintain seal.
11. The vial is placed into ultra-sonic water bath at 25 C for 30 minutes.
12. The vial is then removed from bath, left to cool to room temperature and then placed on vortex mixer for 10 seconds.
13. 3 mL of the solution is then syringed.
14.A 0.20 um syringe filter is placed on the syringe for transfer to a GC vial.
15. The vial is then capped and run on a GC.
16. Resultant graph containing total area count and the internal standard area count is compared against a calibration curve to determine the residual isocyanate monomer.

### EXAMPLES

In the following examples, the abbreviations correspond to the following materials.

| Trade Name | Company/City | Material |
|---|---|---|
| TA | TA Instruments, New | |
| | Castle, DE | |
| CD 9055 | Sartomer, Exetor, PA | acidic acrylate adhesion promoter |
| M 90 | Baker Hughes, Houston, | alkane wax |
| | TX | |
| BDMAEE | | bis(2-dimethylaminoethyl)ether |
| DETA | | diethylene triamine |
| HMDI | | dicyclohexylmethane-4,4′- |
| | | diisocyanate |
| Desmodur w | Covestro LLC, Baytown, | dicyclohexylmethane-4,4′- |
| | TX | diisocyanate |

### Example 1

| | Grams |
|---|---|
| Internal Phase | |
| methyl palmitate | 111.8 |
| n-octadecane | 19.8 |
| alkane wax, M 90 | 1.31 |
| dicyclohexylmethane-4,4′-diisocyanate | 14.6 |
| Water Phase 1 | |
| water | 192.1 |
| polyvinyl alcohol solution 10% | 34.3 |
| silicon dioxide | 2.3 |
| Water Phase 2 | |
| water | 68.8 |
| diethylenetriamine | 5.04 |

A water phase 1 preparation is begun by mixing all components and then holding at 65° C. A water phase 2 is prepared at room temperature and mixed until homogeneous in a separate container. The internal phase preparation is begun by mixing all components, except dicyclohexylmethane-4,4′-diisocyanate, and then heated to 65° C. until the alkane wax is completely dissolved. Dicyclohexylmethane-4,4′-Diisocyanate is then added to the internal phase until clear and homogenous. The internal phase is added to water phase 1, and then milled to form a stable emulsion at target size of 20 um over 20 minutes at 65° C. After milling, water phase 2 is transferred into the batch over 10 minutes and the batch is heated to 92° C. in 60 minutes, then held at 92° C. for 18 hours. The final median size of the microcapsules is 22.2 um.

### Example 2

| | Grams |
|---|---|
| Internal Phase | |
| methyl palmitate | 125 |
| n-octacosane | 6.55 |
| alkane wax, M 90 | 1.31 |
| dicyclohexylmethane-4,4′-diisocyanate | 14.6 |
| Water Phase 1 | |
| water | 192.1 |
| polyvinyl alcohol solution 10% | 34.3 |
| silicon dioxide | 2.3 |
| Water Phase 2 | |
| water | 68.8 |
| diethylenetriamine | 5.04 |

This example is made by following the same procedure as Example 1. The final median size of capsules is 19.9 um.

### Example 3

| | | Grams |
|---|---|---|
| Internal Phase | methyl palmitate | 166.7 |
| | n-octadecane | 8.7 |
| | n-octacosane | 9 |
| | alkane wax, M 90 | 1.4 |
| | dicyclohexylmethane-4,4′- | 15 |
| | diisocyanate (Desmodur w) | |
| Water Phase 1 | water | 240 |
| | sodium laureth sulfate | 2.2 |
| | BDMAEE | 0.4 |
| Crosslinking agent | diethylenetriamine | 1 |
| pH adjustment agent | 21.5% NaOH | 4.5 |

The water phase preparation is begun by mixing 2.2 grams of sodium laureth sulfate, 0.4 grams of BDMAEE to 240 grams of water with a re-circulating water bath set to 65° C. The internal phase preparation is begun in another beaker by mixing 166.7 grams of methyl palmitate, 8.7 grams of n-octadecane, 9 grams of octacosane, and 1.4 grams of M90 at 65° C. The internal phase is mixed at 65° C. until the M90 is dissolved. 15 grams of 4,4′-methylene bis(cyclohexyl isocyanate) is then added to the internal phase and mixed until clear and homogenous. The internal phase is added to the water phase, and then, with mixer set to 1500-1600 rpm, milled to form a stable emulsion at target size (i.e. 20 um) at 65° C. At the end of milling, the mixer is turned off and the mill blade is replaced with a mixing blade. 1.0 grams of diethylenetriamine (DETA) is added. The batch is hold at 65 C for 50 min, and then heated to 70° C. in 60 minutes. 4.5 grams of 21.5% NaOH is added, and the hold at 70° C. in 60 minutes The batch is heated to 80° C. in 120 min, and then to 85° C. in 150 minutes, then held at 85° C. for 24 hours. The final median size of the microcapsules is 19.4 um.

### Example 4

| | | Grams |
|---|---|---|
| Internal Phase | methyl palmitate | 166.7 |
| | n-octadecane | 8.7 |
| | n-octacosane | 9 |
| | alkane wax, M 90 | 1.4 |
| | dicyclohexylmethane-4,4′- | 25 |
| | diisocyanate (Desmodur w) | |
| Water Phase | water | 240 |
| | sodium laureth sulfate | 2.2 |
| Crosslinking agent | BDMAEE | 0.4 |
| | diethylenetriamine (DETA) | 1 |
| pH adjustment agent | 21.5% NaOH | 4.5 |

The water phase and internal phase preparation are made following the procedure in Example 3. The crosslinking agent is prepared by mixing 0.4 grams of BDMAEE with 1.0 grams of diethylenetriamine (DETA) until homogenous. 25 grams of 4,4′-methylene bis(cyclohexyl isocyanate) is then added to the internal phase and mixed until clear and homogenous. The internal phase is added to water phase, and with mixer set to 1500-1600 rpm, milled to form a stable emulsion at target size (i.e. 20 um) at 65° C. At the end of milling, the mixer is turned off and the mill blade is replaced with a mixing blade. The crosslinking agent is added. The batch is held at 65° C. for 50 min, and then heated to 70° C. in 60 minutes. 4.5 grams of 21.5% NaOH is added, and then held at 70° C. for 60 minutes The batch is heated to 80° C. in 120 min, and then to 85° C. in 150 minutes, then held at 85° C. for 36 hours. The final median size of the microcapsules is 22.8 um.

### Example 5

| | | Grams |
|---|---|---|
| Internal Phase | methyl palmitate | 166.7 |
| | n-octadecane | 8.7 |
| | n-octacosane | 9 |
| | alkane wax, M 90 | 1.4 |
| | dicyclohexylmethane-4,4′-diisocyanate | 12 |
| | (Desmodur w) | |
| | polymeric diphenylmethane diisocyanate | 3 |
| | (pMDI)(Mondur MR-light) | |
| Water Phase | water | 240 |
| | sodium laureth sulfate | 2.2 |
| Crosslinking agent | BDMAEE | 0.4 |
| | diethylenetriamine (DETA) | 1 |
| pH adjustment agent | 21.5% NaOH | 4.5 |

The water phase, crosslinking agent and internal phase preparation are made following the procedure in Example 4. The isocyanate monomers are prepared by mixing 12 grams of 4,4′-methylene bis(cyclohexyl isocyanate) with 3 grams of polymeric diphenylmethane diisocyanate until homogenous. The isocyanate monomers are then added to the internal phase and mixed until clear and homogenous. The balance of batch making and curing process follow the steps of Example 4. The final median size of the microcapsules is 22.2 um.

### Example 6

| | | Grams |
|---|---|---|
| Internal Phase | methyl palmitate | 166.7 |
| | n-octadecane | 8.7 |
| | n-octacosane | 9 |
| | alkane wax, M 90 | 1.4 |
| | dicyclohexylmethane-4,4′-diisocyanate | 20 |
| | (Desmodur w) | |
| | polymeric diphenylmethane diisocyanate | 5 |
| | (pMDI)(Mondur MR-light) | |
| Water Phase | water | 240 |
| | sodium laureth sulfate | 2.2 |
| Crosslinking agent | BDMAEE | 0.4 |
| | diethylenetriamine (DETA) | 1 |
| pH adjustment agent | 21.5% NaOH | 4.5 |

The example follows the procedure of Example 5, except for the isocyanate monomers, mixing 20 grams of 4,4′-methylene bis(cyclohexyl isocyanate) with 5 grams of polymeric diphenylmethane diisocyanate. The final median size of the microcapsules is 20 um.

Table 1 summarizes various parameters according to the above described test methods of the compositions described in Examples 1 to 6.

Table 2 summarizes residual free isocyanate and residual free amine by the Residual Free Amine Monomer measurement and Residual Free Isocyanate Monomer measurement methods set forth above.

TABLE 1

| | | | | | | | Rating | Rating | Rating % | | |
|---|---|---|---|---|---|---|---|---|---|---|---|
| | | Latent | Melting | % Wt @ | % Free | Rating | Latent | Melting | Wt @ | Rating % | |
| Examples | Delta T | Heat | Point | 180 C. | Core | Delta T | Heat | Point | 180° C. | Free Core | TEI |
| Example 1 | 7.5 | 175.4 | 27.3 | 98.99 | 0.5 | 0.25 | 1 | 0.21 | 1.00 | 0.84 | 13331 |
| Example 2 | 5.5 | 186.1 | 30.0 | 97.35 | 1.3 | 0.45 | 1 | 0.03 | 1.00 | 0.58 | 2095 |
| Example 3 | 5.7 | 188.0 | 29.2 | 97.6 | 1.2 | 0.43 | 1 | 0.53 | 1.00 | 0.60 | 41022 |
| Example 4 | 4.4 | 170.6 | 28.6 | 97.6 | 0.4 | 0.56 | 1 | 0.93 | 1.00 | 0.87 | 135408 |
| Example 5 | 4.8 | 178.5 | 28.8 | 99.1 | 0.7 | 0.52 | 1 | 0.80 | 1.00 | 0.77 | 95680 |
| Example 6 | 4.7 | 166.6 | 28.6 | 99.5 | 0.1 | 0.53 | 1 | 0.93 | 1.00 | 0.97 | 142941 |

TABLE 2

| | % Residual | % Residual |
|---|---|---|
| Examples | Isocyanate | Amine |
| Example 3 | 0.97 | 0.03 |
| Example 4 | 1.05 | 0.03 |
| Example 5 | 1.26 | 0.02 |
| Example 6 | 2.00 | 0.03 |

In Table 1, in applying the TEI formula, a rating is used in the columns prefaced “Rating”. For Delta T, the rating is based on a sliding inverse scale of 0 to 1 assigned on the basis of 0 for Delta T greater than 10° C., and 1 for a Delta T of 0° C.

For the Rating Latent Heat, a value of 1 is assigned if the latent heat is at least 165 Joules per gram, and a value of 0 is assigned if less than 165 Joules per gram.

For Rating Melting Point, a value between 0 and 1 is assigned based on a value of 1 at 28.5° C. The range is 27° C. to 30° C. for values between 0 to 1. The assigned value is based on the position in the stated range and relative difference from 28.5° C., expressed as a fraction from 1 to 0 starting with 28.5° C. as a value of 1. Above or below this range a value of 0 is assigned.

For Rating % Wt at 180° C., a value between 0 and 1 is assigned based on 0 for 94% or less remaining; 1 for 96% or greater remaining; and 0 to 1 for the range 94% to 96%.

For Rating % Free Core, a value between 0 and 1 is assigned based on 0 to 1 for free wax of less than 3%. 1 indicates no free wax detected.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. All references, including publications, patent applications, and patents, cited herein are hereby incorporated by reference. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims.

What is claimed is:

1. A composition comprising particles of a microencapsulated phase change material, the particles comprising a core and a shell that encapsulates the core, the shell comprising a polyurea obtained by polymerizing a multifunctional isocyanate monomer and an amine monomer, prepared by:
i) providing a water phase with an emulsifier;
ii) providing an internal phase of a core material and a multifunctional isocyanate monomer soluble or dispersible in the internal phase;
iii) adding the internal phase to the water phase under high speed agitation to form an emulsion comprising droplets of the internal phase dispersed in the water phase;
iv) adding a multifunctional amine monomer to the emulsion thereby forming an initial polyurea shell at an interface of the internal phase droplets and water phase mixture;
v) continuing reaction of the amine monomer and water with the multifunctional isocyanate monomer forming additional polyurea shell;
the particles having a Thermal Efficiency Index greater than 0.

2. The composition of claim 1 comprising in addition an amine catalyst added to the water phase in step i) or added to the emulsion, and in step v) or an additional step vi) continuing reaction of the amine catalyst and water with the multifunctional isocyanate monomer forming additional polyurea shell.

3. The composition of claim 1 having a residual content of free amine monomer wherein the amount of free amine monomer equals 2% or less by weight of the particles.

4. The composition of claim 1 having a residual content of free isocyanate monomer wherein the amount of free isocyanate monomer equals 1% or less by weight of the particles.

5. The composition of claim 2 wherein the amine catalyst is bis(2-dimethylaminoethyl)ether.

6. The composition of claim 2 wherein the isocyanate is a multifunctional isocyanate selected from aliphatic and aromatic isocyanates.

7. The composition of claim 6 wherein the isocyanate is dicyclohexylmethane-4,4′-diisocyanate.

8. The composition of claim 2 wherein the amine monomer is a multifunctional amine selected from diethylene triamine, triethylene triamine, 1,6-diamine-n-hexane and hexamethylene diamine.

9. The composition of claim 1 wherein the emulsifier is sodium laureth sulfate.

10. The composition of claim 1, said composition having a Thermal Efficiency Index of at least 600.

11. The composition of claim 1, wherein said particle's core material comprises a material selected from the group consisting of 50 to 97 wt % of a methyl ester derived from palm oil, and from 0.1 to 20 wt % of a straight chain alkane based on total weight of the core.

12. The composition of claim 11 wherein the core includes in addition from 0.1 to 25 wt % of a wax selected from the group of waxes consisting of alkane wax, polyethylene wax, carnauba wax, candelilla wax, vegetable wax, beeswax and paraffin wax.

13. The composition of claim 11, wherein said particle comprises from about 20 to about 99 wt % of a core material.

14. The microencapsulated phase change material according to claim 11, having a differential scanning calorimetric melt point peak T1 of the microencapsulated phase change material of not more than 30° C. and a resolidification peak T2 of not less than 18° C., and wherein the absolute value of the difference between the respective melt point peak T1 and resolidification peak T2 is not more than 10° C.

15. The microencapsulated phase change material according to claim 12, having a differential scanning calorimetric melt point peak T1 of the microencapsulated phase change material of not more than 30° C. and a resolidification peak T2 of not less than 18° C., and wherein the absolute value of the difference between the respective melt point peak T1 and resolidification peak T2 is not more than 10° C.

16. The microencapsulated phase change material according to claim 14 wherein the methyl ester is selected from methyl laurate, methyl myristate, methyl palmitate, methyl stearate, or methyl oleate.

17. The microencapsulated phase change material according to claim 14 wherein the phase change material has a latent heat of at least 165 Joules per gram.

18. The microencapsulated phase change material according to claim 14 wherein the phase change material comprises a blend of methyl palmitate, octacosane and alkane wax.

19. The microencapsulated phase change material according to claim 14 wherein the phase change material comprises:
from 50 to 95 wt % of methyl palmitate;
from 0 to 20 wt % of octacosane; and
from 0 to 40 wt % of polyethylene wax.

20. The microencapsulated phase change material according to claim 14 wherein the phase change material comprises:
(A) 55 to 95 wt % of methyl palmitate;
(B) 0.1 to 10 wt % of octacosane; and
(C) 0 to 30 wt % of one or more additional phase change materials other than phase change materials (A) and (B),
wherein the weight percent of (A), (B), and (C) is based on the total weight of the phase change material.

21. An article of manufacture incorporating the microencapsulated phase change material according to claim 1.

22. The article of manufacture according to claim 1, wherein the article is selected from textiles, foams, pillows, mattresses, bedding, cushions, cosmetics, medical devices, packaging, cooling fluids, wallboard, and insulation.
